(19) United States
(12) Patent Application Publication
(10) Pub. No.: US 2013/0042674 A1
(43) Pub. Date: Feb. 21, 2013

(54) COMPRESSION SENSOR GASKET ASSEMBLY AND METHOD OF CONSTRUCTION THEREOF

(71) Applicants: David M. Toth, Brighton, MI (US); Frederick R. Hatch, Ann Arbor, MI (US); Brent Sedlar, Ann Arbor, MI (US)

(72) Inventors: David M. Toth, Brighton, MI (US); Frederick R. Hatch, Ann Arbor, MI (US); Brent Sedlar, Ann Arbor, MI (US)

(21) Appl. No.: 13/211,550

(22) Filed: Aug. 17, 2011

(51) Int. Cl. G01M 15/08; B23P 17/00

(52) U.S. Cl. 73/114.18; 29/525.14

(57) ABSTRACT

A compression sensor gasket assembly includes a gasket body and a pressure sensor assembly having a sensor tip and an externally threaded portion. The gasket body has opposite sides extending between an opening configured to register with a cylinder bore of an internal combustion engine and an outer periphery. A notch extends into the outer periphery to a recessed surface. A sensor receptacle configured for at least partial receipt of the pressure sensor assembly extends from the recessed surface to the opening. A nut is disposed in the notch with internal threads of the nut being aligned for threaded engagement with the externally threaded portion of the pressure sensor assembly. The nut has bifurcated fingers extending laterally outwardly from an outer surface. The bifurcated fingers have inner surfaces bonded to at least one of the opposite sides of the gasket body to facilitate proper orientation of the pressure sensor assembly.

### BACKGROUND OF THE INVENTION

1. Technical Field

This invention relates generally to gaskets for internal combustion engines, and more particularly to compression gaskets incorporating a pressure sensor for both forming a seal about a chamber within an internal combustion engine and monitoring combustion pressure within the chamber.

2. Related Art

Internal combustion engines have chambers in which high pressures are generated. Generally, a pair of members mate with one another to form the chamber or chambers, such as a cylinder head and engine block, for example, with a gasket body being received between the members to provide a gas/fluid tight seal. In addition to the gasket body, it is known to integrate a separate pressure sensor assembly with the gasket body to indicate the pressure within the chamber. Pressure sensor assemblies are known to be threaded to the gasket body, and in some instances a nut is fixed to the gasket body to facilitate threading the pressure sensor assembly to the gasket body. In order to ensure the pressure sensor assembly is properly aligned within a slot or opening of the gasket body, it is necessary to fix the nut to the gasket body in proper alignment relative to the slot or opening. Otherwise, if the nut is not properly aligned, the assembly of the pressure sensor assembly is made more difficult, and in some cases, the integrity of the pressure sensor assembly may be compromised.

A compression sensor gasket assembly and method of construction thereof in accordance with the invention provides a nut that is properly aligned with a slot or opening in the gasket body in a economical, efficient manner.

### SUMMARY OF THE INVENTION

A compression sensor gasket assembly includes a gasket body and a pressure sensor assembly having a sensor tip and an externally threaded portion. The gasket body has opposite sides extending between an opening configured to register with a cylinder bore of an internal combustion engine and an outer periphery. A notch extends into the outer periphery to a recessed surface and a sensor receptacle, configured for at least partial receipt of the pressure sensor assembly, extends from the recessed surface to the opening. A nut is disposed in the notch and with internal threads of the nut being configured for threaded engagement with the externally threaded portion of the pressure sensor assembly. The nut has bifurcated fingers extending laterally outwardly from an outer surface. The bifurcated fingers have inner surfaces bonded to at least one of the opposite sides of the gasket body.

In accordance with another aspect of the invention, a method of constructing a compression sensor gasket assembly is provided. The method includes providing a pressure sensor assembly having a sensor tip and an externally threaded portion and providing a gasket body having opposite sides extending between an opening configured to register with a cylinder bore of an internal combustion engine and an outer periphery. Further, forming a notch extending into the outer periphery of the gasket body to a recessed surface. Further yet, forming a sensor receptacle extending from the recessed surface of the notch to the opening in the gasket body. In addition, providing a nut having internal threads configured for threaded engagement with the externally threaded portion of the pressure sensor assembly and a pair of diametrically opposite bifurcated fingers extending laterally outwardly from an outer surface of the nut. Then, bonding the inner surfaces of the bifurcated fingers to at least one of the opposite sides of the gasket body and threadingly attaching the pressure sensor assembly to the nut.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a top view of a gasket assembly constructed in accordance with one presently preferred embodiment of the invention;

FIG. 2A is a partial perspective view of the gasket of FIG. 1 with a pressure sensor assembly remove therefrom and a nut exploded therefrom;

FIG. 2B is a partial perspective view showing a locating fixture positioned to align the nut with the gasket body;

FIG. 2C is a view similar to FIG. 2A shown with the nut fixed to the gasket body; and

FIG. 3 is a top view of a gasket body similar to FIG. 1 showing a locating fixture positioned to simultaneously align a plurality of nuts with the gasket body in accordance with another presently preferred embodiment of the invention.

### DETAILED DESCRIPTION OF PRESENTLY PREFERRED EMBODIMENTS

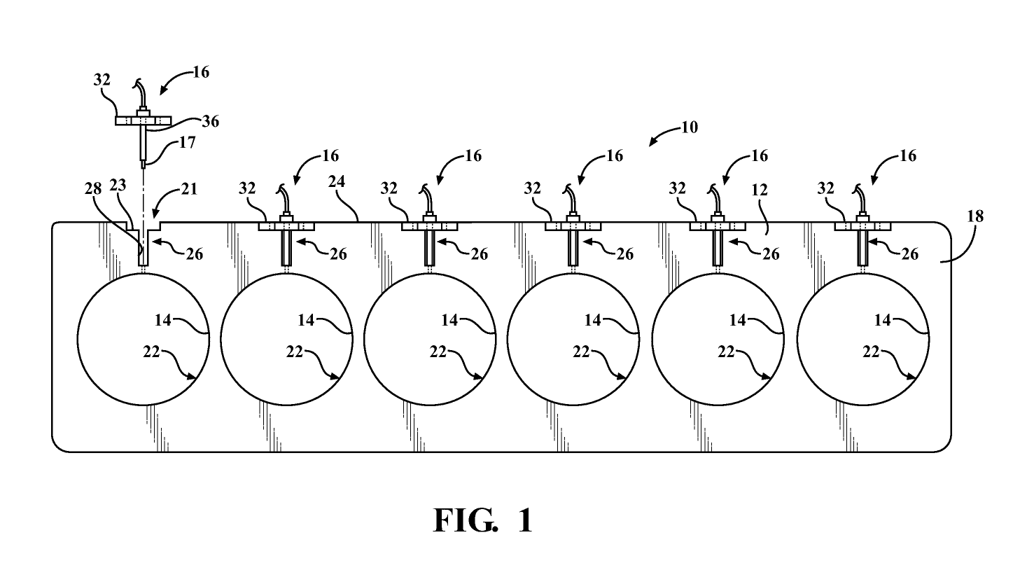

Referring in more detail to the drawings, FIG. 1 illustrates a compression sensor gasket assembly, referred to hereafter as gasket assembly 10, constructed in accordance with one presently preferred embodiment of the invention. The gasket assembly 10 has a metal distance layer, referred to hereafter as gasket body 12, with one or more through openings, also referred to through passages 14, for the passage of fluid or gas therethrough, such as an opening configured to register in axial alignment with a cylinder bore, also referred to as cylinder chamber in which a piston reciprocates (not shown), for example. The gasket assembly 10 has a pressure sensor assembly 16 at least partially releasably attached in sealed engagement with the gasket body 12. The pressure sensor assembly 16 includes a pressure sensor 17 that is configured to sense pressure within the associated through passage 14 and within the cylinder bore being sealed. In service, the pressure sensor 17 can be readily removed from the gasket body 12 and replaced, as necessary. Accordingly, servicing the pressure sensor 17 is made easy and economical.

The gasket body 12 can be provided as a monolithic piece of material having flat or substantially flat sealing surfaces 18, 20 configured for sealed engagement directly with a cylinder head, engine block or one or more functional layers fabricated from a resilient metal (not shown), such as spring steel, for example, having sealing beads, including half and/or full sealing beads, as desired. The through passages 14 have an inner surface or periphery 22 configured to register with the passage being sealed. To facilitate attaching the pressure sensor assembly 16 to the gasket body 12, the gasket body 12 has a plurality of recessed notches 21 extending into an outer periphery 24 to a recessed surface 23 with pressure sensor receptacles, also referred to as passages 26 extending from the recessed surface 23 into each through passage 14. Each passage 26 can be formed in part as a recessed slot (not extending through the full thickness of the body 12); in part as a through slot (extending completely through the thickness of the body 12), and is part or fully as an enclosed passage, also referred to as tubular passage, extending between the opposite sealing surfaces 18, 20. For example, the passages 26 can be formed having through slots 28 extending through the opposite sides 18, 20 from recessed surfaces 23 toward a respective through passage 14. The through slots 28 can be stamped, milled or otherwise machined through the sealing surfaces 18, 20. In addition, an enclosed tubular passage, represented as a drilled passage 30, extends from the respective through slot 28 radially inwardly between the opposite sides 18, 20 to the inner periphery 22. The drilled passage 30 can be sized, at least in part, having a close fit, such as a slight loose or line-to-line fit with a portion of the pressure sensor 17, or it can be enlarged for receipt of an adaptor sleeve, seal, heat shield, or other type of fitting.

To facilitate attaching and locating the sensor assembly 16 to the gasket body 12, a fastening member, also referred to a nut 32, is disposed within the recessed notch 21 to abut the recessed surface 23 of the notch 21. The nut 32 has a fastener opening, shown as an internally threaded opening 34 configured for threaded engagement with an externally threaded portion 36 of the pressure sensor assembly 16. The nut 32 is shown extending flush or substantially flush with the outer periphery 24 of the gasket body 12 with an outer surface 38 of the nut 32 extending upwardly from the upper sealing surface 18 and downwardly from the lower sealing surface 20. The nut 32 has bifurcated fingers, shown as a pair of bifurcated fingers 40, 42 extending laterally outwardly diametrically opposite one another from the outer surface 38. The bifurcated fingers 40, 42 each having inner surfaces 44 bonded to at least one, and shown as being bonded to both of the opposite sides 18, 20 of the gasket body 12. The inner surfaces 44 are preferably bonded via a weld joint formed in a welding process to the opposite sides 18, 20, such as in a resistance welding or spot welding process, for example. Each of the bifurcated fingers 42, 44 are spaced from one another sufficiently to receive the opposite sides 18, 20 therein in a line-to-line, or preferably slightly loose fit. Then, upon being fully received and assured of being properly aligned, wherein the nut 32 is generally brought into abutment with the recessed surface 23 of the notch 21, the bifurcated fingers 40, 42 can be compressed into abutment with the respective opposite sides prior to forming the weld joints. Then, with the fingers 40, 42 brought into abutment with the opposite sides, the weld joints are formed.

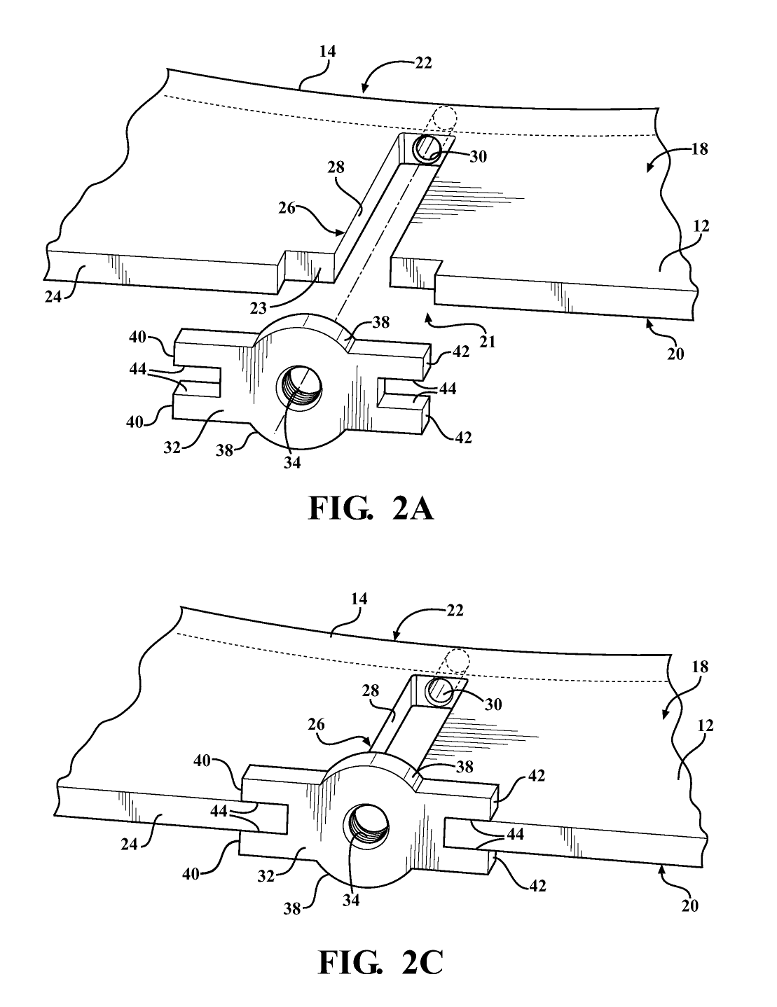

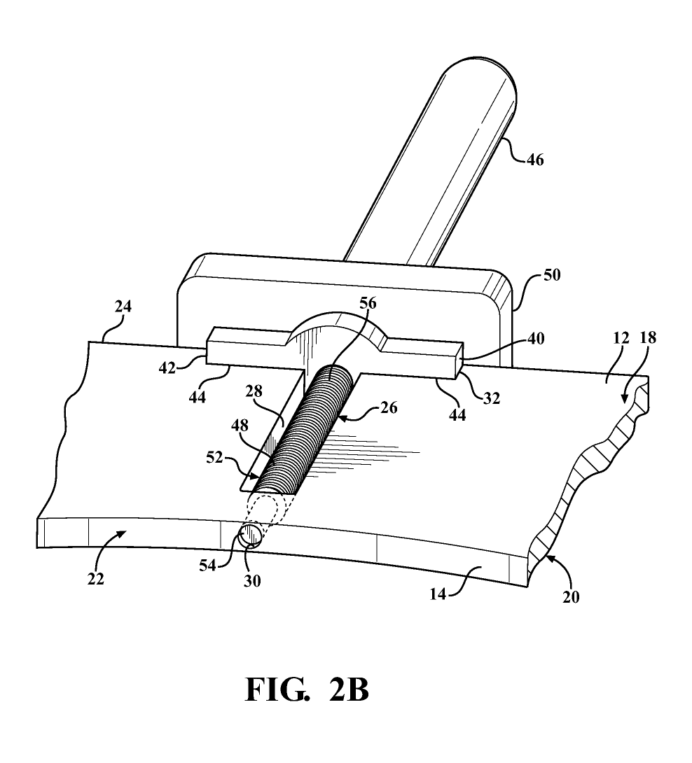

As shown in FIG. 2B, to facilitate aligning the weld nut 32 so that the internally threaded opening 34 of the nut 32 is properly aligned with the pressure sensor assembly passages 26, and particularly with the tubular passages 30, a locating tool, also referred to as location fixture 46 can be utilized during assembly. The locating fixture has a has an elongate body portion 48 sized for receipt within the pressure sensor passages 26 and an end flange portion 50. The body 48 is shown having an intermediate section 52 sized for a clearance fit within the through slots 28 and an end pilot section 54 having a reduced diameter from the intermediate section 52. The pilot section 54 is sized for a line-to-line or slightly loose fit with the tubular passage 30. The end flange portion 50 is at least slightly wider than the notches 21 and extends laterally outwardly generally equidistant from diametrically opposite sides of the intermediate section 52. If preferred, the intermediate section 52 can be provided with external threads 56 adjacent the flange portion 50, wherein the threads 56 are configured for threaded engagement with the internal threads of the nut 32.

During construction, the nut 32 is disposed on the elongate body 48, wherein the intermediate section 52 is closely received through the internally threaded opening 34 of the nut 32. If provided, the threads 56 of the fixture 46 are threaded with the threads 34 of the nut 32 until the nut 32 abuts the flange portion 50 of the fixture 46, thereby preventing relative movement therebetween. Otherwise, if the fixture does not have external threads, the close fit between the intermediate section 52 and the threaded opening 34 of the nut 32 substantially prevents relative movement therebetween. Then, the pilot section 54 of the fixture 46 is inserted into the tubular passage 30 and the bifurcated fingers 40, 42 are disposed in overlying relation with the opposite sealing surfaces 18, 20 of the gasket body 12. With the nut 32 being restrained or substantially restrained against relative movement with the fixture 46 and with the pilot section 54 also being restrained or substantially restrained against relative lateral movement within the tubular passage 30, the internal threads 34 of the nut 32 are assured of being properly axially aligned with the tubular passage 30. Further, the bifurcated fingers 40, 42 are compressed toward one another into abutment with the sealing surfaces 18, 20, and then the weld joints are formed via the desired welding process, e.g. resistance or spot welding, to bond the fingers 40, 42 with the respective sealing surfaces 18, 20. Upon forming the weld joints, the fixture 46 is then remove, such as via being pulled out of the passage 26 or turned to threadingly detach the nut 32 from the fixture 46.

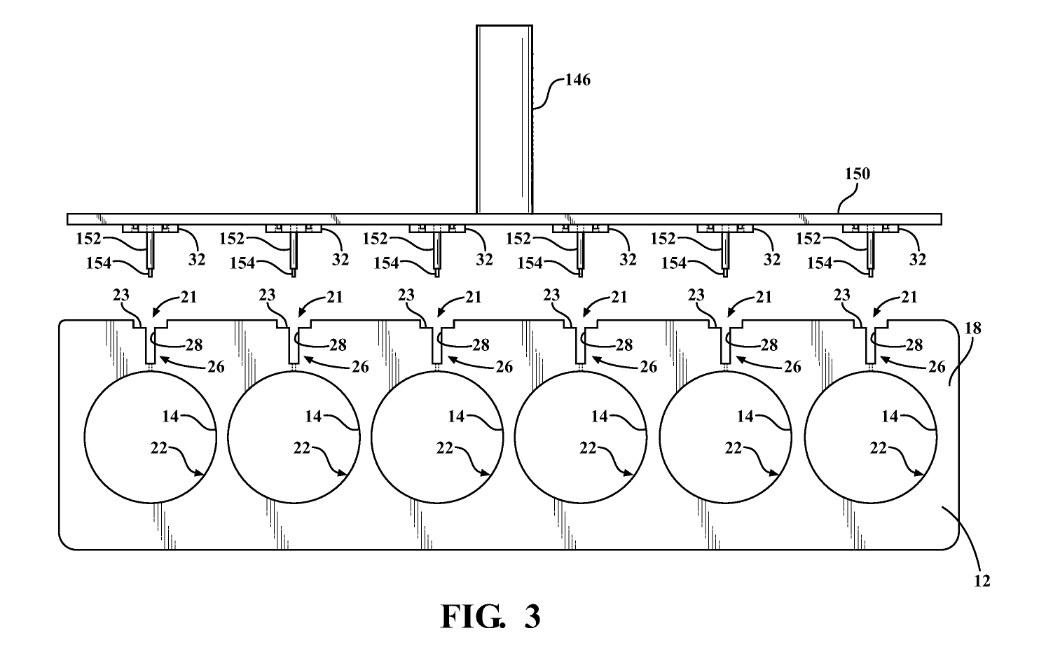

As shown in FIG. 3, in accordance with another aspect of constructing the gasket assembly 10, wherein the same reference numerals as used above, offset by a factor of 100, are used to identify like features, rather than aligning and assembling the weld nuts 32 to the gasket body 12 individually and separately from one another via the fixture 46, a fixture 146 is provided to allow the weld nuts 32 to be aligned on the gasket body 12 simultaneously with one another. The fixture 146 has an elongate flange portion 150 with a plurality of intermediate section 152 and pilot sections 154 extending therefrom for automatic alignment with corresponding passages 26 in the gasket body 12. Thus, the weld nuts 32 can all be positioned and fixed, e.g. bonded or welded, to the gasket body 12 in their proper positions for receipt of the sensors therein.

Obviously, many modifications and variations of the present invention are possible in light of the above teachings. It is, therefore, to be understood that within the scope of the appended claims, the invention may be practiced otherwise than as specifically described.

What is claimed is:

1. A compression sensor gasket assembly, comprising:
a pressure sensor assembly having a sensor tip and an externally threaded portion;
a gasket body having opposite sides extending between an opening configured to register with a cylinder bore of an internal combustion engine and an outer periphery, a notch extending into said outer periphery to a recessed surface, a sensor receptacle configured for at least partial receipt of said pressure sensor assembly extending from said recessed surface to said opening; and
a nut disposed in said notch and having internal threads configured for threaded engagement with said externally threaded portion of said pressure sensor assembly and an outer surface, bifurcated fingers extending laterally outwardly from said outer surface, said bifurcated fingers having inner surfaces bonded to at least one of said opposite sides of said gasket body.

2. The compression sensor gasket assembly of claim 1 wherein said nut has a pair of said bifurcated fingers diametrically opposite one another.

3. The compression sensor gasket assembly of claim 1 further comprising at least one weld joint bonding said inner surfaces of said bifurcated fingers to at least one of said opposite sides.

4. The compression sensor gasket assembly of claim 3 further comprising weld joints bonding said inner surfaces of said bifurcated fingers to both of said opposite sides.

5. The compression sensor gasket assembly of claim 1 wherein said nut abuts said recessed surface.

6. The compression sensor gasket assembly of claim 5 wherein said nut is substantially flush with said outer periphery of said gasket body.

7. A method of constructing a compression sensor gasket assembly, comprising:
providing a pressure sensor assembly having a sensor tip and an externally threaded portion;
providing a gasket body having opposite sides extending between an opening configured to register with a cylinder bore of an internal combustion engine and an outer periphery;
forming a notch extending into said outer periphery to a recessed surface;
forming a sensor receptacle extending from the recessed surface to the opening;
providing a nut having internal threads configured for threaded engagement with the externally threaded portion of the pressure sensor assembly and a pair of diametrically opposite bifurcated fingers extending laterally outwardly from an outer surface of the nut;
bonding the inner surfaces of the bifurcated fingers to at least one of the opposite sides of the gasket body; and
threadingly attaching the pressure sensor assembly to the nut.

8. The method of claim 7 further including performing the bonding by forming a weld joint.

9. The method of claim 8 further including forming weld joints between the bifurcated fingers and both of the gasket body opposite sides.

10. The method of claim 8 further including forming the weld joint in a resisting weld process.

11. The method of claim 7 further including bring the nut in substantially flush relation with the outer periphery of the gasket body prior to bonding the fingers with at least one of the opposite sides.

12. The method of claim 7 further including extending a locating fixture through the nut and through the sensor receptacle to align the internal threads of the nut with the sensor receptacle prior to bonding the nut to the gasket body.

13. The method of claim 7 further including providing a plurality of the nuts and extending a locating fixture through the nuts and through a plurality of sensor receptacles to align the internal threads of the nuts with the sensor receptacles prior to bonding the nuts to the gasket body.

14. The method of claim 13 further including bonding the plurality of nuts to the gasket body simultaneously with one another.

15. The method of claim 7 further including compressing the inner surfaces of the bifurcated fingers into abutment with the opposite sides of the gasket body prior to bonding.
